(19) United States
(12) Patent Application Publication
(10) Pub. No.: US 2018/0110602 A1
(43) Pub. Date: Apr. 26, 2018

(54) DEVICE FOR BRUSHING THE TEETH, HAVING MULTIPLE BRUSHES WITH ROTARY AND/OR OSCILLATING MOTION

(71) Applicant: GLARESMILE S.R.L., Milan (IT)

(72) Inventor: Aldo Daniele Dominici, San Donato Milanese (IT)

(73) Assignee: GLARE SMILE S.R.L.

(21) Appl. No.: 15/561,844

(22) PCT Filed: Apr. 1, 2016
(86) PCT No.: PCT/EP2016/057198

§ 371 Date: Sep. 26, 2017

(30) Foreign Application Priority Data
Apr. 8, 2015 (IT) MI2015A000498

(51) Int. Cl. A61C 17/34; A61C 17/24; A46B 13/04; A46B 11/00

(52) U.S. Cl. CPC A61C 17/349; A61C 17/24; A61C 17/3463; A46B 2200/1066; A46B 13/04; A46B 11/001; A61C 17/3472

(57) ABSTRACT

A device for brushing teeth having multiple brushes that provide rotary and/or oscillating motion. The device has a right lateral brush, a left lateral brush, and an upper brush. Each of the three brushes is connected to, and driven by, a respective supporting rod. Each of the supporting rods is driven by a respective gear. The device includes a motor or engine for generating rotational movement which is transferred to each of the gears by a transmission. The transmission is configured to simultaneously provide both rotary and lateral movement to the brushes, thereby creating an oscillating motion.

The present invention regards a device for brushing the teeth, having a head composed of multiple brushes, preferably two lateral brushes and a upper brush. In particular, the invention comprises a mechanism that permits the rotation of the brushes and their simultaneous vertical oscillation, so that it is possible, in example, to brush the incisor, canine, premolar and molar teeth, reaching if necessary either the part under the cementoenamel junction.

As known, in the present state of the art, there are many models of electric brushes, from that available commonly on the market, to the more advanced used in the dentist's treatment room.

The U.S. Pat. No. 3,551,932 patent discloses one of the first models of electric devices that includes a unique brush placed at the end of a rod rotating in respect to its longitudinal axis. An electric engine permits to activate the rotary motion of the rod and respective brush. With reference to models having multiple brushes, the CA 2462422 patent describes a device having two rotating brushes placed side by side, as well as in the U.S. Pat. No. 7,992,244 patent. The US 2004/143917 patent application describes a similar object where the second brush has the rotary axis a little bit angled in respect to that of the first brush. Instead, the EP 1059049 patent discloses a device having three brushes that are aligned and laterally placed each other.

The idea on which the present invention is based is to increase the level of effectiveness in the operations of cleaning of teeth, by placing a certain number of brushes on more sides, and by giving them a motion that, other than rotary friction on the surface of teeth is also oscillating vertically, that means perpendicular to the longitudinal rotary axis and simultaneously parallel to the long axis of teeth, and not perpendicular as in the common electrical toothbrushes. In such a way it is possible to reach the part of teeth under the cementoenamel junction, usually hard to be reached by normal toothbrushes.

The present invention overcomes all the drawbacks of the prior art by proposing as a main objective to describe a device having multiple brushes with a rotary motion and/or oscillating motion perpendicular to the axis of rotation and parallel to the axis of tooth, in order to achieve the cleaning of teeth simultaneously on more sides, by friction of their surface. The brushes are activated by engines of electrical, mechanical or hydraulic type, and a mechanism is included converting the rotary motion in respect to the longitudinal axis to a vertical oscillating motion.

In particular, both the right lateral brush and the left lateral brush have simultaneously a rotary motion in respect to the longitudinal axis and a vertical oscillating motion perpendicular to their longitudinal axis.

Another objective is to permit an embodiment where either the upper brush has simultaneously a rotary motion in respect to the longitudinal axis and a vertical oscillating motion perpendicular to their longitudinal axis.

Another further objective is to define a geometrical shape and a configuration of the brushes in the device able to achieve the insertion of the front part inside the oral cavity of a person, with the lateral brushes placed to the respective sides of teeth and the upper brush placed on the upper part of teeth.

Another objective is to introduce a mechanism of convergence in the brushes that permits to intercept easily the teeth having different size so that a more effective cleaning operation of teeth can be achieved.

Another objective is that both the right lateral brush and the left lateral brush are directed according to a convergent direction in respect to their longitudinal axis, so that the device permits to intercept easily the teeth having different size and can therefore have a more effective cleaning operation of teeth.

Another further objective is that the brushes include bristles having all the same length, or some with a specific length and others with a different length, that the bristles are placed in rows oriented at 90° or at 30°, or according to any other angle, one in respect to the adjacent one.

And then, an objective of the present invention is to protect the soft tissues inside the oral cavity from said rotating and/or oscillating brushes of said device.

Another further objective is that both the right lateral brush and the left lateral brush have simultaneously a rotary motion in respect to the longitudinal axis, a vertical oscillating motion perpendicular to their longitudinal axis, and a horizontal oscillating motion perpendicular to their longitudinal axis.

Finally, another objective is to comprise further means containing, distributing and dispensing washing liquids and/or treatment substances, to associate to the action of friction of brushes on teeth, in order to further increase the level of effectiveness in the operation of cleaning the teeth.

Therefore, it is specific subject of the present invention a device for brushing the teeth, having multiple brushes with rotary and/or oscillating motion, comprising:
a right lateral brush placed at the front part of a right supporting rod, which is inserted inside a right directive channel and has the rear part connected to a right gear; a left lateral brush placed at the front part of a left supporting rod, which is inserted inside a right directive channel and has the rear part connected to a left gear; a upper brush placed at the front part of a upper supporting rod, which is inserted inside a upper directive channel and has the rear part connected to a upper gear;
transmission means of a rotary motion, generated by one or more engines that can be of electrical, mechanical or hydraulic type, towards the above said left gear, right gear and upper gear,
characterized in that comprising a motion conversion mechanism from a rotary motion around a longitudinal axis to a simultaneous rotary motion and vertical oscillating motion perpendicular to the same longitudinal axis and parallel to the larger axis of teeth, wherein:
   said right and left supporting rods include a respective front part and rear part, with the end of the rear part connected to a respective gear in a off-center position in respect to the rotary axis; said right directive channel and left directive channel have a conical profile that is first convergent and then divergent until it reaches a out opening that is vertically extended; the rotary motion of the gear transmits a conical motion directed from the rear part of the respective rod, to a vertical oscillating motion, in the front part of the rod; the vertically oscillating motion of the front part of the respective rod is expressed at the end, that exits from the out opening that is vertically extended, and which is transmitted respectively to the right lateral brush and to the left lateral brush.

It is here underlined that the proposed solution represents a significant inventive step in respect to the prior art, because it is actually the only compatible device with the small space available around the teeth, because the channels have both the functions of protecting in front of the moving parts, and conversion from a rotary motion to a oscillating motion, that is necessary for a complete cleaning.

Without said oscillating motion it would be impossible for some rotary brushes to clean all the surface of teeth, including teeth with gingival recession, because they would be too large to be placed laterally of teeth, or they would be too small to reach all the surface to be brushed.

The present invention is now being described according to non-limiting examples, with particular reference to the figures of the enclosed drawings, where:

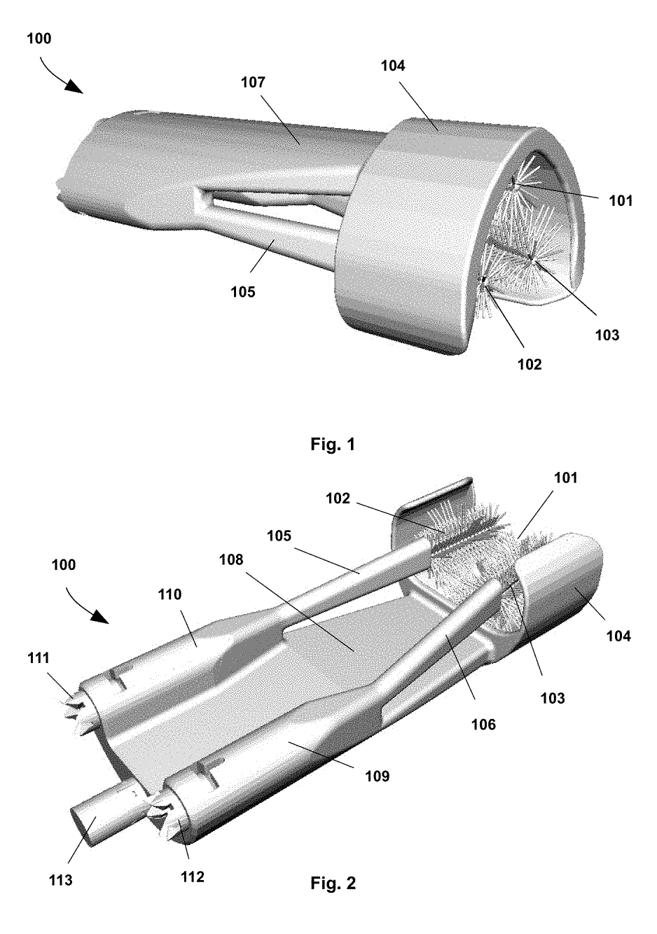

FIG. 1 is a front perspective view of the upper right part of a device for brushing the teeth according to the present invention;

FIG. 2 is a front perspective view of the lower left part of the same device for brushing the teeth of FIG. 1;

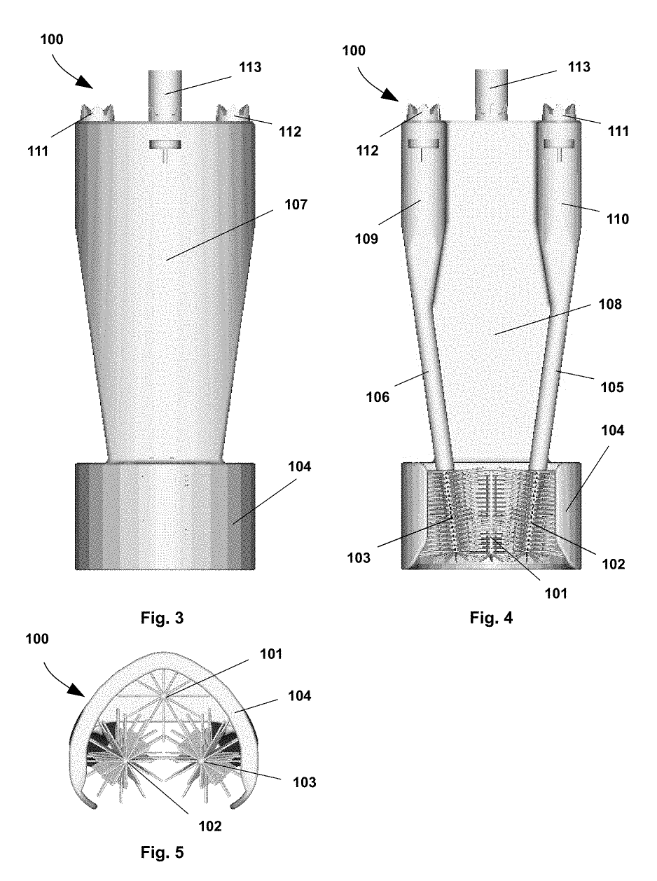

FIG. 3 is a top view of the same device of FIG. 1;

FIG. 4 is a bottom view of the same device of FIG. 1;

FIG. 5 is a front view of the same device of FIG. 1;

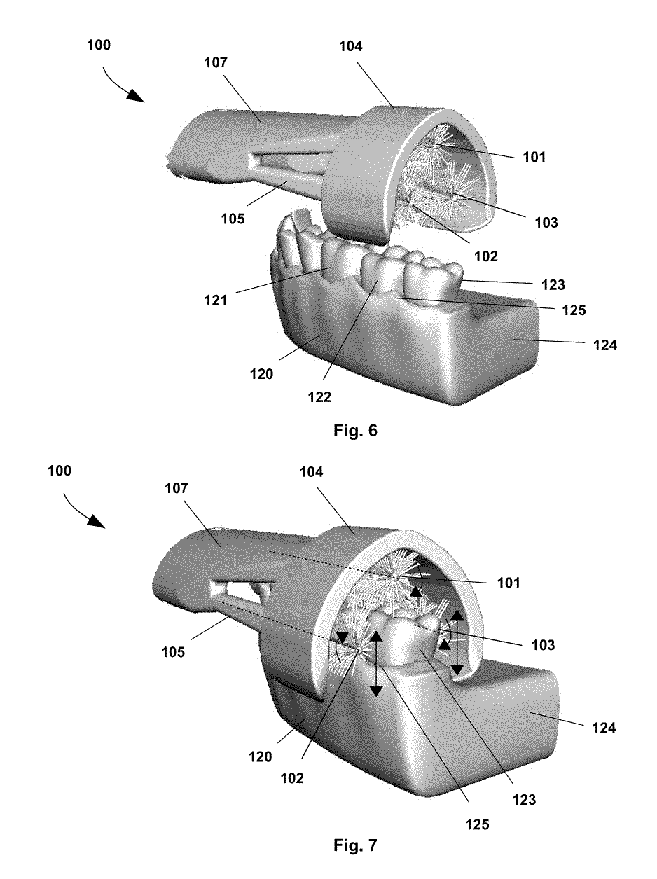

FIG. 6 is a front perspective view of the upper right part of the same device of FIG. 1, close to the left part of the lower arch in the dentition of a person;

FIG. 7 is a front perspective view of the upper right part of the same device of FIG. 1, applied to the left part of the lower arch in the dentition of a person;

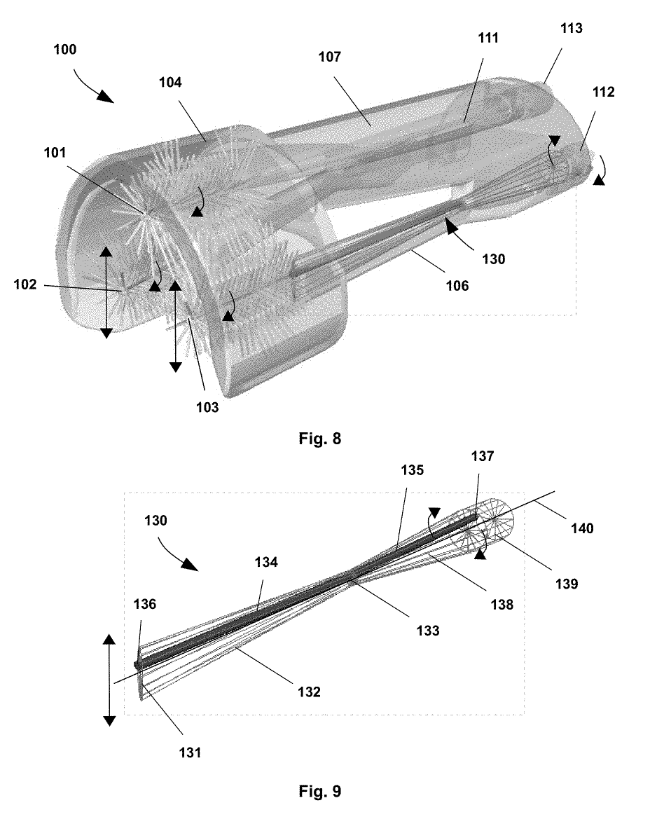

FIG. 8 is a front perspective view of the upper left part of the same device of FIG. 1, with the inner components shown in transparency;

FIG. 9 is a schematic view of a mechanism converting a longitudinal rotary motion to a vertical oscillating motion, installed at the lateral brushes of the device of FIG. 1.

It is underlined that only few of the many conceivable embodiments of the present invention are here described, which are just some specific non-limiting examples, having the possibility to describe many other embodiments based on the disclosed technical solutions of the present invention.

FIGS. 1 and 2 show a device 100 for brushing the teeth, according to the present invention, in a perspective view where the upper right part and the lower left part are represented, and in FIGS. 3, 4 and 5 the same device 100 is represented in respect to a top, bottom and front view.

The device 100 comprises a main body wherein multiple brushes, having a rotary and/or oscillating motion, are installed. In particular, the main body further comprises a right directive channel 105, 110, a left directive channel 106, 109, and an upper directive channel. A right supporting rod is inserted inside the right directive channel 105, 110, a left supporting rod is inserted inside the left directive channel 106, 109, while a upper supporting rod is inserted inside the upper directive channel.

A right lateral brush 102 is placed in the front part of the right supporting rod, a left lateral brush 103 is placed in the front part of the left supporting rod, and a upper brush 101 is placed in the front part of the upper supporting rod.

The rear part of the right supporting rod is connected to a right gear 111, the rear part of the left supporting rod is connected to a left gear 112, the rear part of the upper supporting rod is connected to a upper gear 113.

The device 100 further includes means of transmission of a rotary motion, generated by one or more engines that can be of electrical, mechanical or hydraulic type, towards said left gear 112, right gear 111 and upper gear 113.

The original and characterizing aspect of the present invention is given by the fact that device 100 comprises a mechanism converting the rotary motion around the longitudinal axis to a simultaneous rotary and vertical oscillating motion perpendicular to the same longitudinal axis and parallel to the long axis of teeth. In such a way, both the right lateral brush 102 and the left lateral brush 103 move according to a simultaneous rotary motion and a vertically oscillating motion in respect to their longitudinal axis.

More in particular, with reference to FIGS. 8 and 9, both the right supporting rod and the left supporting rod have a front part 134 and a rear part 135. The end 137 of the rear part 135 is connected to a respective gear 139 placed in a off-centered position in respect to the axis of rotation 140. The above said said right 105, 110 and left 106, 109 directive channels have a profile that is first convergent 138, until they reach a knot 133, and then divergent 132 until they reach a out opening that is vertically extended 131. The rotary motion of the gear 139 transmits a conic motion directed from the rear part 135 of the respective rod, to a vertical oscillating motion in the front part 134 of the rod, passing through a central part that is bound at knot 133.

The vertical oscillating motion of the front part 134 of the respective rod is expressed at the end 136 that exits from the out opening that is vertically extended 131, and which is transmitted respectively to the right lateral brush 102 and to the left lateral brush 103.

In such a way, both the right lateral brush 102 and the left lateral brush 103 move simultaneously according to a rotary motion around their respective longitudinal axis and a vertically oscillating motion respect to the same longitudinal axis.

In an alternative embodiment of the present invention, said right and left supporting rods include a respective front part 134 and rear part 135, with the end 137 of the rear part 135 connected to a respective gear 139 in a centered position in respect to the rotary axis 140. Said right 105, 110, and left 106, 109, directive channels have a conical profile that is first convergent 138, until they reach a knot 133, and then divergent 132 until they reach a out opening that is vertically extended 131.

The front part 134 is curved in respect to said rear part 135. The rotary motion of the gear 139 transmits a rotary motion directed from the rear part 135 of the respective rod, to a vertical oscillating motion in the front part 134 of the rod. The vertical oscillating motion of the front part 134 of the respective rod is expressed at the end 136 that exits from the out opening that is vertically extended 131, and which is transmitted respectively to the right lateral brush 102 and to the left lateral brush 103.

In an alternative embodiment of the present invention, either the upper brush 101 moves simultaneously according to a rotary motion around its respective longitudinal axis and a vertical oscillating motion in respect to the same longitudinal axis. In this case, again with reference to FIGS. 8 and 9, either said upper supporting rod includes a respective front part 134 and rear part 135. The end 137 of the rear part 135 is connected to a respective gear 139 in a off-center position in respect to the rotary axis 140. Said upper directive channel has a conical profile that is first convergent 138, until it reaches a knot 133, and then divergent 132, until it reaches a out opening that is vertically extended. The rotary motion of the gear 139 transmits a conical motion directed from the rear part 135 of the respective rod, to a vertical oscillating motion, in the front part 134 of the rod, passing through a central part bound to a knot 133. The vertical oscillating motion of the front part 134 of the respective rod is expressed at the end 136 as a vertical oscillating motion that exits from the out opening that is vertically extended 131, and that it is transmitted respectively to the upper brush 101. In such a way, the upper brush 101 moves simultaneously according to a rotary motion around its respective longitudinal axis and a vertical oscillating motion in respect to the same longitudinal axis.

FIGS. 6 and 7 show as the same device 100 is applied first at a close distance, and then directly on the left part of the lower arch of the dentition of a person.

According to the invention, the inter-axial distance between said right lateral brush 102 and left lateral side 103 is adaptable by using a proper tuning mechanism, furthermore said inter-axial distance between the upper brush 101 and right lateral brush 102, or left lateral brush 103, is adaptable too by using a proper mechanism. In such a way, the device 100 can be adapted to the opening size of the oral cavity, and to the teeth size of different persons.

Furthermore, said right lateral brush 102 and left lateral brush 103, with their respective right supporting rod and left supporting rod, contained in their respective right directive channel 105, 110 and left directive channel 106, 109, are directed according to a convergent direction in respect to their longitudinal axis, so that the same device 100 can easily intercept teeth of different sizes and therefore can lead to a more effective operation of teeth cleaning. The convergence of the channels is effective because their flexibility and the flexibility of their axis permits to adapt themselves to different sizes and shapes; that in view of the fact that small teeth are followed in mouth by large teeth, and without the above mechanism the brushes would be kept far from the small teeth.

According to the different embodiments of the invention, said right lateral brush 102, left lateral brush 103 and upper brush 101 comprise a set of bristles that can be all of the same length, or some of them can be of a fixed length and others of different length. The bristles can be arranged following lines at a 90° angle each other, or at 30° each other, or following a fixed angle each in respect to the adjacent line. In such a way, the device 100 can achieve different levels of treatment and therefore can achieve different levels of effectiveness in the cleaning operations of teeth.

The device 100 further comprises a radial element, called shield 104, that extends itself around said right lateral brush 102, said left lateral brush 103 and upper brush 101, having at the same time a open front part. In such a way, the device 100 can work properly, and at the same time the soft tissues inside the oral cavity are protected from said rotating and/or oscillating brushes of the same device 100, preventing that the brushing mechanism could be affected or could slow down by soft tissues going in contact with brushes or pressing them on the teeth.

Said right supporting rod, left supporting rod and/or upper supporting rod are composed of a material that is flexible and strong at the same time, like in example a polymeric plastic material or an harmonic steel.

In such a way, the conversion of the rotary motion of said rear part 135 to the oscillating motion of the front part 134 is achieved effectively, although the quick and intense forces affecting said rods of the device, occupying as small space as possible and making the unique oscillatory motion compatible with the small space available inside the mouth, because it is the same structure that generates the oscillation and therefore there is not space occupied by any additional component.

According to an alternative embodiment, said vertically extended opening 131 can have a horizontal width that is greater than the width of the rod's end 136, so that the same end 136, in addition to said vertical oscillating motion, expresses a horizontal oscillating motion, that is transmitted to said right lateral brush 102 and left lateral brush 103, so that the brushing action of said brushes is increased, in the horizontal direction and in the vertical direction, and it is achieved a higher level of effectiveness in the operations of teeth cleaning.

Furthermore, the device 100 can include tanks for containing cleaning liquids and/or substances for teeth whitening, means for directing the same liquids and/or substances towards the front side of the device, means for spraying and/or pushing out, on command, the same liquids and/or substances. In such a way, it is provided an additional action, in respect to the brushing of the teeth, and this action includes said cleaning liquids and/or whitening substances, leading to a further improvement in the operations of teeth cleaning.

Therefore, the above examples show that the present invention reaches all the expected objectives. In particular, it permits to achieve a device having multiple brushes with a rotary motion and/or oscillating motion perpendicular to the axis of rotation and parallel to the axis of tooth, in order to achieve the cleaning of teeth simultaneously on more sides, by friction of their surface. The brushes are activated by engines of electrical, mechanical or hydraulic type, and a mechanism is included converting the rotary motion in respect to the longitudinal axis to a vertical oscillating motion. In particular, both the right lateral brush and the left lateral brush have simultaneously a rotary motion in respect to the longitudinal axis and a vertical oscillating motion perpendicular to their longitudinal axis.

Furthermore, an embodiment of the invention includes an upper brush that has simultaneously a rotary motion in respect to the longitudinal axis and a vertical oscillating motion perpendicular to their longitudinal axis.

Further according to the invention, the brushes in the device have a geometrical shape and a configuration able to achieve the insertion of the front part inside the oral cavity of a person, with the lateral brushes placed to the respective sides of teeth and the upper brush placed on the upper part of teeth.

Then, a mechanism of convergence in the brushes permits to intercept easily the teeth having different size, so that a more effective cleaning operation of teeth can be achieved.

According to the invention, both the right lateral brush and the left lateral brush are directed according to a convergent direction in respect to their longitudinal axis, so that the device permits to intercept easily the teeth having different size and can therefore have a more effective cleaning operation of teeth.

Furthermore, the brushes include bristles having all the same length, or some with a specific length and others with a different length, the bristles can be placed in rows oriented at 90° or at 30°, or according to any other angle, one in respect to the adjacent one.

Then, the device of the present invention protects the soft tissues inside the oral cavity from said rotating and/or oscillating brushes of said device.

Further according to the invention, both the right lateral brush and the left lateral brush have simultaneously a rotary motion in respect to the longitudinal axis, a vertical oscillating motion perpendicular to their longitudinal axis, and a horizontal oscillating motion perpendicular to their longitudinal axis.

Finally, the device can comprise further means containing, distributing and dispensing washing liquids and/or treatment substances, to associate to the action of friction of brushes on teeth, in order to further increase the level of effectiveness in the operation of cleaning of the teeth.

The present invention has been described by making reference to some non-limiting examples and following some preferred embodiments; however it goes without saying that modifications and/or changes could be introduced by those skilled in the art without departing from the relevant scope, as defined in the enclosed claims.

1-10. (canceled)

11. A device for brushing teeth having multiple brushes with rotary and/or oscillating motion, the device comprising:
a right lateral brush (102) placed at the front part of a right supporting rod, which is inserted inside a right directive channel (105, 110) and has the rear part connected to a right gear (111); a left lateral brush (103) placed at the front part of a left supporting rod, which is inserted inside a right directive channel (106, 109) and has the rear part connected to a left gear (112); a upper brush (101) placed at the front part of a upper supporting rod, which is inserted inside a upper directive channel and has the rear part connected to a upper gear (113);
a transmission means of a rotary motion, generated by one or more engines that can be of electrical, mechanical or hydraulic type, towards the above said left gear (112), right gear (111) and upper gear (113),
a motion conversion mechanism for translating rotary motion around a longitudinal axis to a simultaneous rotary motion and vertical oscillating motion perpendicular to the same longitudinal axis and parallel to the larger axis of teeth;
wherein the right and left supporting rods include a respective front part (134) and rear part (135), with the end (137) of the rear part (135) connected to a respective gear (139) in an off-center position in respect to the rotary axis (140); said right directive channel (105, 110) and left directive channel (106, 109) have a conical profile that is first convergent and then divergent (132) until it reaches a out opening that is vertically extended (131); the rotary motion of the gear (139) transmits a conical motion directed from the rear part (135) of the respective rod, to a vertical oscillating motion, in the front part (134) of the rod; the vertically oscillating motion of the front part (134) of the respective rod is expressed at the end (136), that exits from the out opening that is vertically extended (131), and which is transmitted respectively to the right lateral brush (102) and to the left lateral brush (103).

12. The device of claim 11 wherein said right and left supporting rods include, as an alternative, a respective front part (134) and rear part (135), with the end (137) of the rear part (135) connected to a respective gear (139) in a central position in respect to the rotary axis (140); said right (105, 110) and left (106, 109) directive channels have a profile that is first convergent (138), until they reach a knot (133), and then divergent (132) until they reach an out opening that is vertically extended (131); said front part (134) is curved in respect to said rear part (135), at the central part located in said knot (133); the rotary motion of the gear (139) transmits a rotary motion directed from the rear part (135) of the respective rod, to a vertical oscillating motion in the front part (134) of the rod; the vertical oscillating motion of the front part (134) of the respective rod is expressed at the end (136) that exits from the out opening that is vertically extended (131), and which is transmitted respectively to the right lateral brush (102) and to the left lateral brush (103).

13. The device of claim 11 wherein said upper supporting rod includes a respective front part (134) and rear part (135), with the end (137) of the rear part (135) connected to a respective gear (139) in a off-center position in respect to the rotary axis (140); said upper directive channel has a conical profile that is first convergent and then divergent (132) until it reaches an out opening that is vertically extended (131); the rotary motion of the gear (139) transmits a conical motion directed from the rear part (135) of the respective rod, to a vertical oscillating motion, in the front part (134) of the rod, passing through a central part bound to a knot (133); the vertical oscillating motion of the front part (134) of the respective rod is expressed at the end (136) as a vertical oscillating motion that exits from the out opening that is vertically extended (131), and that it is transmitted respectively to the upper brush (101).

14. The device of claim 11 wherein the inter-axial distance between said right lateral brush (102) and left lateral side (103) is adaptable by using a proper tuning mechanism, furthermore said inter-axial distance between the upper brush (101) and right lateral brush (102), or left lateral brush (103), is adaptable too by using a proper mechanism, so that the device (100) can be adapted to the opening size of the oral cavity, and to the teeth size of different persons.

15. The device of claim 11 wherein said right lateral brush (102) and left lateral brush (103), with their respective right supporting rod and left supporting rod, contained in their respective right directive channel (105, 110) and left directive channel (106, 109), are directed according to a convergent direction in respect to their longitudinal axis, so that the same device (100) can easily intercept teeth of different sizes and therefore can lead to a more effective operation of teeth cleaning; the convergence of the channels is effective because their flexibility and the flexibility of their axis permits to adapt themselves to different sizes and shapes; that in view of the fact that small teeth are followed in mouth by large teeth, and without the above mechanism the brushes would be kept far from the small teeth.

16. The device of claim 11 wherein said right lateral brush (102), left lateral brush (103) and upper brush (101) comprise a set of bristles that can be all of the same length, or some of them can be of a fixed length and others of different length, the bristles can be arranged following lines at a 90° angle each other, or at 30° each other, or following a fixed angle each in respect to the adjacent line, so that the device (100) can achieve different levels of treatment and therefore can achieve different levels of effectiveness in the cleaning operations of teeth.

17. The device of claim 11 comprising a radial element, called shield (104), that extends itself around said right lateral brush (102), said left lateral brush (103) and upper brush (101), having at the same time an open front part, so that the device (100) can work properly, and at the same time the soft tissues inside the oral cavity are protected from said rotating and/or oscillating brushes of the same device (100), preventing that the brushing mechanism could be affected or could slow down by soft tissues going in contact with brushes or pressing them on the teeth.

18. The device of claim 11 wherein said right supporting rod, left supporting rod and/or upper supporting rod are composed of a material that is flexible and strong at the same time, like in example a polymeric plastic material or an harmonic steel, so that the conversion of the rotary motion of said rear part (135) to the oscillating motion of the front part (134) is achieved effectively, although the quick and intense forces affecting said rods of the device, occupying as small space as possible and making the unique oscillatory motion compatible with the small space available inside the mouth, because it is the same structure that generates the oscillation and therefore there is not space occupied by any additional component.

19. The device of claim 11 wherein said vertically extended opening (131) can have a horizontal width that is greater than the width of the rod's end (136), so that the same end (136), in addition to said vertical oscillating motion, expresses a horizontal oscillating motion, that is transmitted to said right lateral brush (102) and left lateral brush (103), so that the brushing action of said brushes is increased, in the horizontal direction and in the vertical direction, and it is achieved a higher level of effectiveness in the operations of teeth cleaning.

20. The device of claim 11 comprising tanks for containing cleaning liquids and/or substances for teeth whitening, means for directing the same liquids and/or substances towards the front side of the device, means for spraying and/or pushing out, on command, the same liquids and/or substances, so that it is provided an additional action, in respect to the brushing of the teeth, and this action includes said cleaning liquids and/or whitening substances, leading to a further improvement in the operations of teeth cleaning.
